(19) United States
(12) Patent Application Publication
(10) Pub. No.: US 2024/0060804 A1
(43) Pub. Date: Feb. 22, 2024

(54) MAGNETIC-INDUCTIVE FLOW METER

(71) Applicant: Endress+Hauser Flowtec AG, Reinach (CH)

(72) Inventors: Tobias Brütsch, Basel (CH); Simon Mariager, Basel (CH); Frank Voigt, Weil am Rhein (DE); Markus Rüfenacht, Diepflingen (CH)

(21) Appl. No.: 18/257,981

(22) PCT Filed: Nov. 26, 2021
(86) PCT No.: PCT/EP2021/083227

§ 371 Date: Jun. 16, 2023

(30) Foreign Application Priority Data
Dec. 16, 2020 (DE) 10 2020 133 859.7

(51) Int. Cl. G01F 1/58; G01F 25/10

(52) U.S. Cl. CPC G01F 1/588; G01F 25/10

(57) ABSTRACT

The present disclosure relates to a magnetic-inductive flow meter including a measuring pipe having a measuring pipe body which electrically insulates portions thereof. A device generates a magnetic field that penetrates the measuring pipe body and detects an induced voltage in the medium, which is a function of a velocity of flow. A monitoring device detects damage to the measuring pipe body and comprises at least one electrically conductive conductor. The conductor is separated from the measuring pipe volume by a region of the measuring pipe body when the measuring pipe body is intact. The monitoring device comprises a measuring circuit electrically connected to the conductor and is designed to measure values of a measured variable which is dependent on an impedance of the conductor. The measuring circuit then compares each of the measured values with a reference value or a target value range.

The invention relates to a magnetic-inductive flow meter having a monitoring device which is designed to determine damage to the measuring pipe body.

Magnetic-inductive flow meters are used for determining the flow rate and the volumetric flow of a flowing medium in a pipeline. A magnetic-inductive flow meter has a magnet system that generates a magnetic field perpendicular to the direction of flow of the flowing medium. Single coils are typically used for this purpose; permanent magnets less frequently. In order to realize a predominantly homogeneous magnetic field, pole shoes are additionally formed and attached to the measuring pipe such that the magnetic field lines run over the entire pipe cross-section substantially perpendicularly to the transverse axis or in parallel to the vertical axis of the measuring pipe. A measurement electrode pair attached to the lateral surface of the measuring pipe taps an electrical measurement voltage or potential difference in the medium which is applied perpendicularly to the direction of flow and to the magnetic field and occurs when a conductive medium flows in the direction of flow when the magnetic field is applied. Since, according to Faraday's law of induction, the tapped measurement voltage depends on the velocity of the flowing medium, the flow rate u and, with the aid of a known pipe cross-section, the volumetric flow V can be determined from the induced measurement voltage U.

Magnetic-inductive flow meters are often used in process and automation engineering for fluids, as of an electrical conductivity of approximately 5 μS/cm. Corresponding flow meters are sold by the applicant in a wide variety of embodiments for various fields of application, for example under the name PROMAG.

Due to the high mechanical stability required for measuring pipes of magnetic-inductive flow meters, said pipes usually consist of a metallic support tube with a specifiable strength and width, which is lined internally with an electrically insulating material of specifiable thickness, the so-called liner. For example, DE 10 2005 044 972 A1 and in DE 10 2004 062 680 A1 each describe magnetic-inductive measuring sensors which comprise a measuring pipe which can be inserted into a pipeline and which comprises an inlet-side first end and an outlet-side second end, with a non-ferromagnetic support tube as an outer sheath of the measuring pipe, and a tubular lining, which is accommodated in a lumen of the support tube and consists of an electrically insulating material, for conveying a flowing process medium which is electrically insulated from the support tube.

The lining, which is typically made of a thermoplastic, thermosetting and/or elastomeric plastic, serves, inter alia, for chemical insulation of the support tube from the process medium. In magnetic-inductive measuring sensors, with which the support tube has a high electrical conductivity, for example when using metallic support tube, the lining also serves for electrical insulation between the support tube and the process medium, which prevents short circuiting of the voltage induced in the process medium via the support tube. A corresponding design of the support tube thus makes it possible to adapt the strength of the measuring pipe to the mechanical stresses present in the respective case of use, while by means of the lining an adaptation of the measuring pipe to the electrical, chemical and/or biological requirements applicable for the respective case of use can be realized.

Often, a so-called support body, which is embedded in the lining, is used for fastening the lining. In the patent specification EP 0 766 069 B1, for example, a perforated sheet metal tube welded to the support tube serves as a support body. The support body is connected to the support tube and embedded in the lining by applying the material from which the lining is made to the interior of the support tube. Furthermore, a measuring pipe with a metal housing has become known from patent specification U.S. Pat. No. 4,513,624 A for mechanical stabilization and for electrical shielding. For this purpose, the metal housing surrounds a pipeline leading to the medium.

Furthermore, magnetic-inductive flow meters which have a measuring pipe body formed from an electrically insulating material, for example plastic, ceramic and/or glass are known. With such measuring pipes, an insulating coating is dispensed with.

It has been shown that the electrically insulating lining, as well as the measuring pipe body formed from an electrically insulating material, are subject to erosion despite the use of heavy-duty materials. In particular, substances being measured that carry solid particles, such as sand, gravel, and/or stones, lead to abrasion of the cladding of the pipe and/or the measuring pipe body. The abrasion or deformation of the lining or of the electrically insulating measuring pipe body causes the flow profile of the measuring sensor to change. As a result, the measuring device delivers faulty measured values for the volume or mass flow. In addition, the chemical or electrical insulation between the process medium and the support tube is lost when measuring pipes have an internal lining.

WO 2010/066518 A1 discloses a measuring device for determining a volumetric and/or mass flow of a process medium flowing through a measuring pipe. The measuring pipe comprises a support tube with an internal lining, comprising a first layer and a second layer, and a monitoring electrode embedded between the first layer and the second layer and configured to detect damage to the second/first layer. However, the disadvantage of this is the influencing of the monitoring on the measurement of the volume flow and/or mass flow.

The object of the present invention is therefore to provide an alternative solution for a magnetic-inductive flow meter, with which damage by abrasion to the lining and/or the electrically insulating measuring pipe body can be detected without impairing the measurement performance.

The object is achieved by the magnetic-inductive flow meter according to claim 1.

The magnetic-inductive flow meter according to the invention comprises:
a measuring pipe for conveying a medium in a direction of flow,
   wherein the measuring pipe comprises a measuring pipe body which electrically insulates portions thereof,
   wherein the measuring pipe body surrounds, perpendicular to the direction of flow, a measuring pipe volume in which the medium will be conveyed;
a device for generating a magnetic field that penetrates the measuring pipe body;
a device for detecting an induced voltage in the medium, which voltage is a function of a velocity of flow;
a monitoring device for detecting damage to the measuring pipe body,
   wherein the monitoring device comprises at least one electrically conductive conductor,
   wherein the conductor is separated from the measuring pipe volume at least in portions by a region of the measuring pipe body when the measuring pipe body is intact,
   wherein the monitoring device comprises a measuring circuit,
   wherein the measuring circuit is electrically connected to the at least one conductor and is configured to measure measured values of a measured variable dependent on at least one impedance of the at least one conductor,
      wherein the measuring circuit is configured to compare each of the measured values with a reference value or a target value range.

In contrast to WO 2010 066 518 A1, in which the measuring circuit is configured to measure between a monitoring electrode and a reference electrode in order to deduce a defect in the liner when the measurement signal changes—due to the formation of a charge exchange between the monitoring electrode, the medium and the reference electrode—in the present solution, the impedance of the conductor is monitored and a defect in the measuring pipe body is identified on the basis of a change in the impedance (i.e., for example, the electrical resistance, the phase shift between the excitation and measurement signals, the inductance or the capacitance of the conductor). The impedance can be exclusively the impedance of the electrical conductor, or the impedance of the electrical conductor and further electrical components. In addition, the electrical conductor is preferably exclusively electrically connected to the measuring circuit when the measuring pipe body is intact.

Advantageous embodiments of the invention are the subject matter of the dependent claims.

In one embodiment, the measuring pipe body comprises a support tube with an inner peripheral surface,
wherein the measuring pipe body comprises an electrically insulating liner,
wherein the liner is arranged on the inner peripheral surface of the support tube,
wherein the at least one conductor is at least partially embedded in the liner and is electrically insulated from the medium being conveyed.

In one embodiment, the liner comprises a layer system of at least two layers,
wherein the at least one conductor is arranged at least in portions between the two layers.

The layer system advantageously comprises layers of hard rubber matting or natural rubber matting. Alternatively, the layer system can be formed by a repeated application of a liquid potting compound.

In one embodiment, the at least two layers are bonded to each other by a material bond, at least in portions, by means of an adhesive, wherein the at least one conductor has openings, at least in portions, through which the adhesive extends.

The advantage of the embodiment is that the adhesion between the layers is improved, and blistering between the at least two layers is prevented.

In one embodiment, the at least one conductor extends at least in an inlet portion and an outlet portion of the measuring pipe.

In one embodiment, the at least one conductor extends in the manner of a loop or in the manner of a helix at least in portions along the measuring pipe body.

This has the advantage that a punctiform abrasion can be detected earlier. The loop-like or helical arrangement of the conductor results in the fact that a larger inner peripheral surface is covered by the at least one conductor, and thus the probability of an abrasion that forms on a portion of the at least one conductor increases, as does the detection probability.

In one embodiment, the monitoring device comprises at least two conductors.
wherein the at least two conductors each have a support tube spacing d_{T},
wherein the support tube spacings d T differ from each other at least in one measuring pipe portion.

By using at least two conductors, which are spaced apart in portions from a peripheral surface of the measuring pipe body, and thus also from the medium being conveyed, an abrasion level can be derived. If the inner conductor is severed due to abrasion, this has an effect on the determined measured values. In this state, a first degree of abrasion is present, which, however, allows an error-free measurement of the measured variable which is a function of the flow velocity. If the outer conductors are also severed, a further, in particular final, abrasion level is present, which indicates the need for a repair or a change of the liner. The measuring circuit is configured to determine an abrasion level as a function of the determined measured values.

In one embodiment, the at least two conductors are connected to each other at least via a passive electrical component with an electrical impedance.

This has the technical effect that no short circuit forms in the case of medium contacting the conductor, which could have a considerable influence on the flow measurement.

In one embodiment, the measuring circuit is connected via two measuring points on the component and via two further measuring points to ends of the at least two conductors,
wherein the measuring circuit can sequentially measure the four measuring points with respect to each other.

In one embodiment, the monitoring device comprises at least four conductors,
wherein pairs of conductors of the at least four conductors are connected to each other via a single passive electrical component,
wherein the at least four conductors are connected to the measuring circuit,
wherein, when the measuring pipe body is intact, the determined measured values are a function of the impedance of the at least four conductors and the at least two components.

In one embodiment, the monitoring device has at least two passive electrical components, each having an electrical impedance,
wherein the at least two components are connected to each other in series or in parallel via the at least two conductors.

In one embodiment, the monitoring device comprises at least one multiplexer,
wherein the multiplexer is configured to sequentially connect the at least two conductors.

The invention is explained in greater detail with reference to the following figures. In the figures:

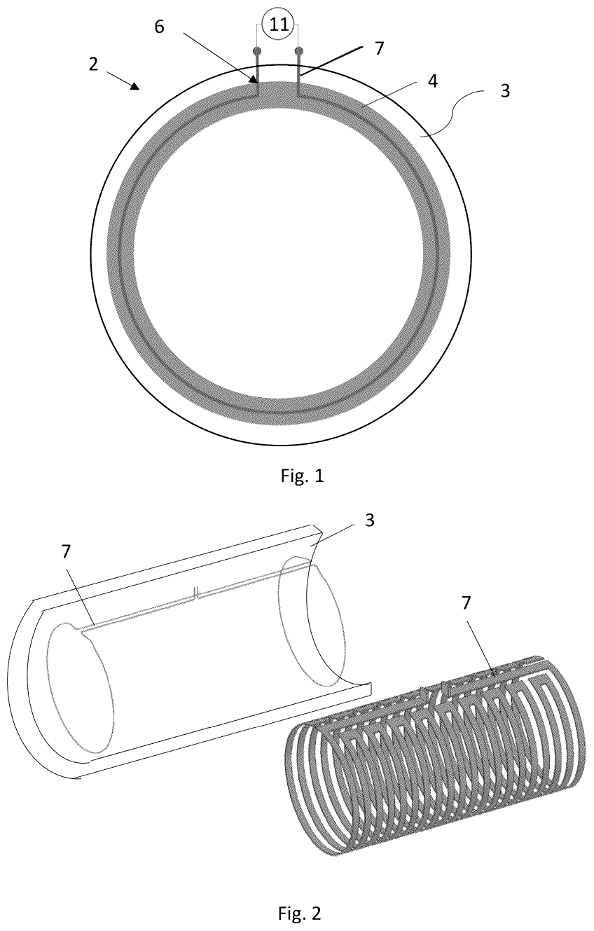

FIG. 1: shows a cross-section through a first embodiment of the magnetic-inductive flow meter according to the invention;

FIG. 2: shows a perspective, partial cutaway view of two embodiments of the monitoring device;

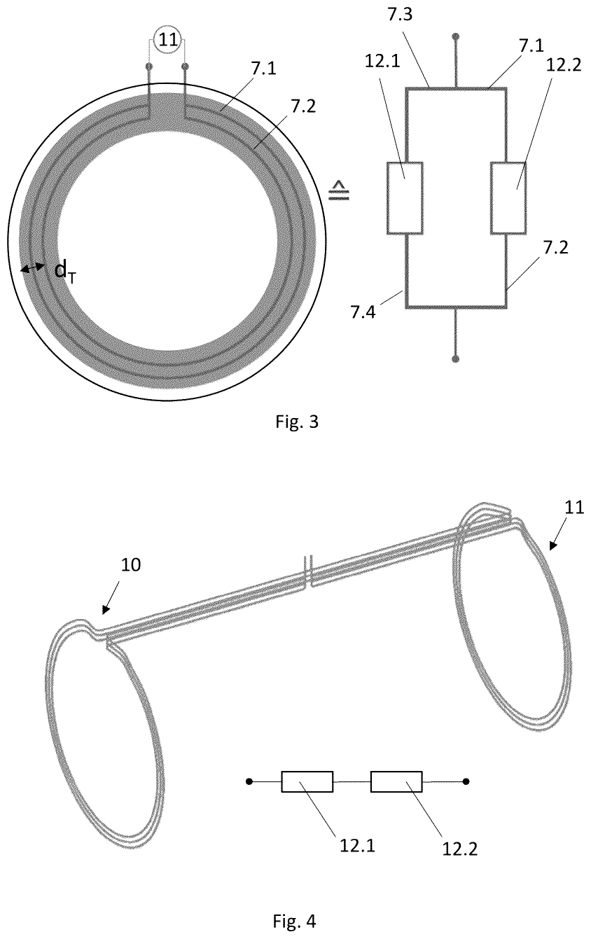

FIG. 3: shows a cross-section through a second embodiment of the magnetic-inductive flow meter according to the invention;

FIG. 4: shows a perspective view of a further embodiment of the monitoring device;

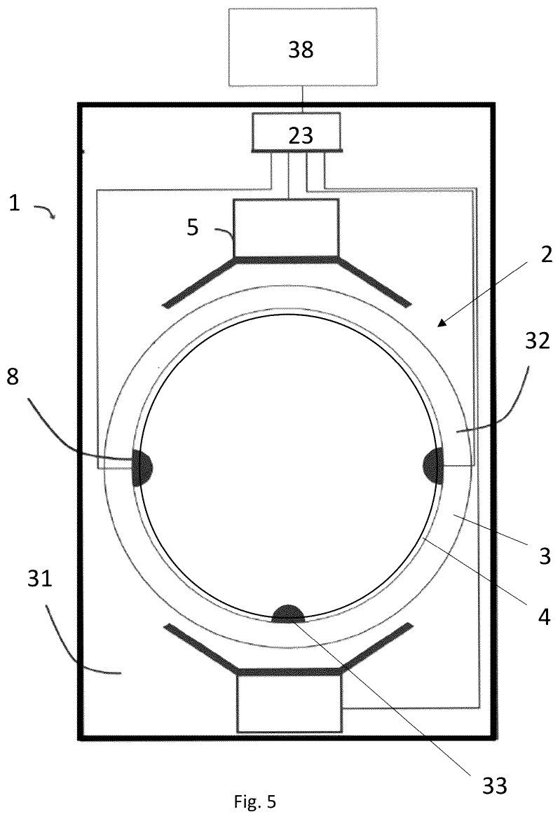

FIG. 5: shows a cross-section through a magnetic-inductive flow meter according to the prior art;

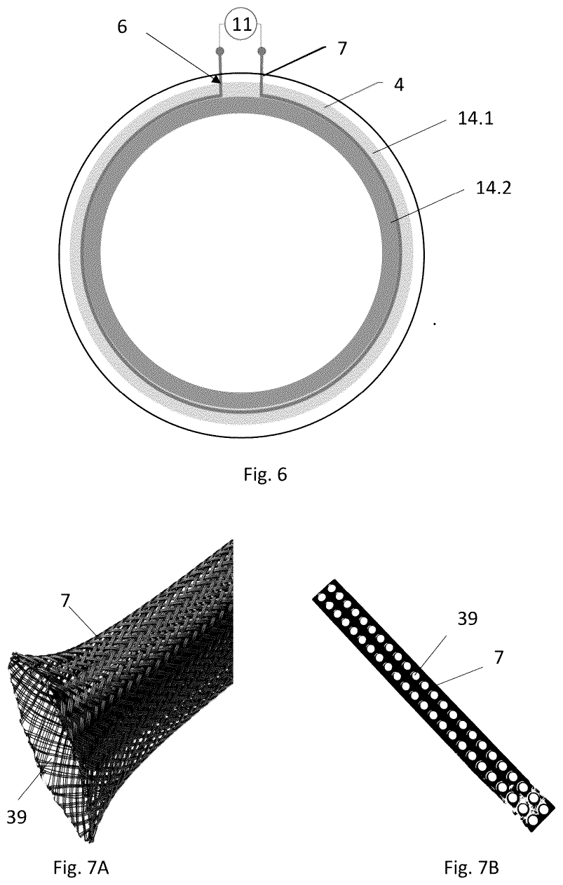

FIG. 6: shows a cross-section through a third embodiment of the magnetic-inductive flow meter according to the invention; and

FIGS. 7A-B: show views of embodiments of the conductor.

FIG. 1 is a cross-section through a first embodiment of the magnetic-inductive flow meter according to the invention. A measuring pipe 2 for conveying a medium in a direction of flow has a measuring pipe body which is electrically insulating in portions and which encloses, perpendicular to the direction of flow, a measuring pipe volume in which the medium will be conveyed. The measuring pipe body comprises a metallic support tube 3 and a liner 4 made of an electrically insulating material arranged on an inner peripheral surface of the support tube 3. Alternatively, the entire measuring pipe body can be formed from a plastic—for example, as a cast part—and the conductor 7 can be at least partially cast into the measuring pipe body. A monitoring device 6 for detecting damage to the measuring pipe body, having at least one or exactly one electrically conductive conductor 7, is at least partially embedded in the liner 4 and, when the measuring pipe body is intact, is separated by a region of the measuring pipe body at least in portions from the measuring pipe volume and/or is electrically insulated from the medium being conveyed. In addition, the conductor 7 is designed to be electrically insulating with respect to the electrically conductive support tube 3. Furthermore, the monitoring device 6 comprises a measuring circuit 11 which is electrically connected to the at least one conductor 7 and is configured to measure measured values of a measured variable dependent at least on an impedance of the at least one conductor. The measured values are then each compared with a reference value or a target value range via the measuring circuit. The conductor 7 is arranged at least partially in a circular shape in the liner 4. If abrasion occurs in the liner 4 and the at least one conductor 7, it affects the impedance of the conductor 7, and the measured value of the measuring circuit deviates from the target value range. Preferably, a warning message is generated for the operator of the magnetic-inductive flow meter.

FIG. 2 is a perspective, partial cutaway view of two embodiments of the monitoring device. One embodiment shows exactly one conductor 7 which is arranged in a support tube 3 shown partially cutaway. The support tube 3 can be formed from an electrically insulating plastic, and the conductor 7 extends on an inner peripheral surface of the support tube 3. Furthermore, the conductor 7 extends from an opening to an inlet portion, where it extends along the inner peripheral surface and the inner circumference of the support tube 3. From the inlet portion, the conductor 7 extends further in the longitudinal direction of the support tube 3 up to a outlet portion, where it extends along the inner peripheral surface and the inner circumference of the support tube 3 and assumes an at least partially circular shape. The conductor 7 extends from the outlet portion in the direction of the opening. The conductor 7 is designed as a wire. The first embodiment is very simple, cost-effective and easy to implement. For this purpose, defects caused locally by abrasion cannot be identified with local resolution if they are located exclusively between the inlet portion and the outlet portion. In addition, the measurements taken on the conductor 7 have only a very small influence on the induced voltage which depends on the velocity of flow.

The second embodiment differs from the first embodiment essentially in the shape and the arrangement of the conductor. The depiction of the liner and/or of the support tube has been omitted. The conductor 7 is designed as a strip—that is, it has a width and a height, wherein the width is greater than the height. In addition, the conductor 7 extends in the manner of a loop or a helix along the measuring pipe body, at least in portions. A larger portion of the measuring pipe in which abrasion can be detected is thus covered. The measured values can be electrical resistances of the conductor 7 or impedances which are determined with a temporally variable excitation signal. Alternatively, the phase shift between the excitation signal and the measurement signal can be used as a measured value for determining abrasion. Alternatively, the measuring circuit can be configured to determine the presence of abrasion on the basis of the determined inductance or the capacitance of the conductor 7.

FIG. 3 is a cross-section through a second embodiment of the magnetic-inductive flow meter according to the invention. In the illustrated embodiment, the monitoring device has, in addition to the measuring circuit 11, at least one, and in particular exactly two, conductors 7.1, 7.2. The two conductors 7.1, 7.2 either each have an electrical impedance which is selected such that the measured value determined by means of the measuring circuit 11 does not fall outside the target value range if they contact the medium, and which only does so when the conductor 7 is subjected to abrasion. The two conductors 7.1, 7.2 are connected separately to the measuring circuit 11, or alternatively, as shown, are connected to each other via two node points and only then are connected to the measuring circuit. Alternatively, the at least two conductors 7.1, 7.2 can be connected to each other at least via one, and in particular exactly one, passive electrical component 12, with an electrical impedance, or via multiple electrical components 12.1, 12.2 each with an electrical impedance. The components 12.1, 12.2 are connected in series or in parallel with each other. The at least two conductors 7.1, 7.2 each have different support tube spacings d_{T}, at least in portions. Alternatively, the monitoring device can comprise four conductors 7.1, 7.2, 7.3, 7.4 and two components 12.1, 12.2, each of which are electrically connected to at least two of the four conductors 7.1, 7.2, 7.3, 7.4 and can be measured by the measuring circuit. The measured values determined by means of the measuring circuit when the measuring pipe body is intact are a function of the impedance of the four conductors 7.1, 7.2, 7.3, 7.4 and the at least two electrical components 12.1, 12.2. If one of the four conductors 7.1, 7.2, 7.3, 7.4 is damaged by abrasion, this has an effect on the determined measured values, and a warning is output.

FIG. 4 shows a perspective view of a further embodiment of the monitoring device, which substantially differs from the first embodiment of FIG. 2 in the number of loops created by the at least one—in particular, exactly one—conductor 7. The conductor extends at least three times from the inlet portion 10 to the outlet portion 11 of the measuring pipe, wherein it travels across at least three circular sectors in both the inlet portion 10 and in the outlet portion 11. Alternatively, two electrical components 12.1, 12.2 with stored impedances as reference values can be connected in series with the conductor 7.

FIG. 5 is a magnetic-inductive flow meter 1 known from the prior art. The structure and measuring principle of a magnetic-inductive flow meter 1 are known in principle. A medium having an electrical conductivity is conducted through a measuring pipe 2. The measuring pipe 2 can be designed, for example, as a support tube formed from metal with a lining applied on the inside, or can comprise a measuring pipe body which is substantially formed from an electrically insulating material, such as plastic, ceramic, glass and/or concrete. A device 5 for generating a magnetic field is attached to the measuring pipe 2 such that the magnetic field lines are oriented substantially perpendicular to a longitudinal direction defined by the measuring pipe axis. A saddle coil or a pole shoe with a mounted coil and coil core is preferably suitable as device 5 for generating the magnetic field. When the magnetic field is applied, a potential distribution is produced in the measuring pipe 2, which distribution is tapped with a device 8 for measuring an induced measurement voltage, preferably with two measuring electrodes attached to the inner wall of the measuring pipe 2. As a rule, these are arranged diametrically and form an electrode axis or are intersected by a transverse axis, which runs perpendicularly to the magnetic field lines and the axis of the measuring pipe. On the basis of the measurement voltage U measured, and taking into account the magnetic flux density, the velocity of flow of the medium can be determined and, taking into account the cross-sectional area of the tube, the volumetric flow rate can be determined. In order to prevent the measuring voltage applied to the first and second measuring electrodes from dissipating via a metallic support tube, the inner wall of the support tube is provided with an electrically insulating lining—a so-called liner. The magnetic field built up by the device 5, for example an electromagnet for generating a magnetic field, is generated by a direct current of alternating polarity clocked by means of an operating circuit. This ensures a stable zero point and makes the measurement insensitive to influences due to electrochemical disturbances. A measuring circuit 23 is configured to read out the measurement voltage applied to the first measuring electrode and the second measuring electrodes. An evaluation circuit is configured to determine the flow rate and/or the volume flow of the medium and to output said medium for example via a display 38 to the user. Commercially available magnetic-inductive flow meters 1 have further electrodes in addition to the measurement electrodes. A fill level monitoring electrode (not shown in FIG. 5), which is optimally attached at the highest point in the measuring pipe 2 serves to detect partial filling of the measuring pipe 2, and is configured to relay this information to the user and/or to take into account the fill level when determining the volume flow. Furthermore, a reference electrode, which is usually attached diametrically opposite the fill-level monitoring electrode, or at the lowest point of the pipe cross-section, serves to ensure sufficient grounding of the medium being conveyed.

FIG. 6 is a cross-section through a third embodiment of the magnetic-inductive flow measuring device according to the invention, which substantially differs from the embodiment of FIG. 1 in that the liner 4 comprises a layer system of at least two layers 14.1, 14.2, and the at least one conductor 7 is arranged at least in portions between the two layers. A first layer onto which a further layer of the layer system is applied can preferably be primed with an adhesion promoter. In order for the layers to remain connected to each other, an adhesive, in particular a liquid adhesive, is used. In this case, it is advantageous if the conductor 7 has openings in which the adhesive can extend, so that no air bubbles form during the material bonding of the layers.

FIGS. 7A and 7B show views of embodiments of the conductor 7. On the one hand, the conductor 7 can be formed by a cable or a wire. If the conductor 7 is arranged between two layers of a layer system, it is advantageous if the conductor 7 has openings 39 in which the adhesive connecting the two layers extends and the adhesion between the two layers can be improved. A conductor 7, which consists of a plurality of wires which are braided together in such a way that openings 39 are formed, is a further embodiment of the conductor 7.

Alternatively, the conductor 7 can consist of an aluminum adhesive tape which provides adhesion, a conductive metallic thin-walled and flexible strip, preferably with openings, or a band coated in particular on both sides with an electrically conductive material. In addition, the conductor 7 can be designed as a portion of the liner which is doped in portions, or as a thin film applied in particular in selected regions, and optionally coated with primer.

### LIST OF REFERENCE SIGNS

Magnetic-inductive flow meter 1
Measuring pipe 2
Support tube 3
Liner 4
Device for generating a magnetic field 5
Monitoring device 6
Conductor 7
Device for measuring an induced voltage 8
Inlet portion 9
Outlet portion 10
Measuring circuit 11
Electrical component 12
Multiplexer 13
Layer 14
Measuring circuit 23
Housing 31
Measuring pipe body 32
Reference electrode 33
First monitoring electrode 35
Second monitoring electrode 36
Third monitoring electrode 37
Display 38
Opening 39
Contact surface 40

1-12. (canceled)

13. A magnetic-inductive flow meter, comprising:
a measuring pipe for conveying a medium in a direction of flow;
wherein the measuring pipe comprises a measuring pipe body which electrically insulates portions thereof,
wherein the measuring pipe body surrounds, perpendicular to the direction of flow, a measuring pipe volume in which the medium will be conveyed;
a device for generating a magnetic field that penetrates the measuring pipe body;
a device for detecting an induced voltage in the medium, which voltage is a function of a velocity of flow;
a monitoring device for detecting damage to the measuring pipe body,
wherein the monitoring device comprises at least one electrically conductive conductor,
wherein the conductor is separated from the measuring pipe volume at least in portions by a region of the measuring pipe body when the measuring pipe body is intact,
wherein the monitoring device comprises a measuring circuit,
wherein the measuring circuit is electrically connected to the at least one conductor and is configured to measure measured values of a measured variable dependent at least on an impedance of the at least one conductor,
wherein the measuring circuit is configured to compare each of the measured values with a reference value or a target value range.

14. The magnetic-inductive flow meter according to claim 13,
wherein the measuring pipe body comprises a support tube having an inner peripheral surface,
wherein the measuring pipe comprises an electrically insulating liner,
wherein the liner is arranged on the inner peripheral surface of the support tube,
wherein the at least one conductor is embedded at least in portions in the liner and is electrically insulated from the medium being conveyed.

15. The magnetic-inductive flow meter according to claim 14,
wherein the liner comprises a layer system of at least two layers,
wherein the at least one conductor is arranged at least in portions between the two layers.

16. The magnetic-inductive flow meter according to claim 14,
wherein the at least two layers are connected to each other by a material bond, at least in portions, by means of an adhesive,
wherein the at least one conductor has openings, at least in portions, through which the adhesive extends.

17. The magnetic-inductive flow meter according to claim 13,
wherein the at least one conductor extends at least in an inlet portion and an outlet portion of the measuring pipe.

18. The magnetic-inductive flow meter according to claim 13,
wherein the at least one conductor extends in a loop or in a helix at least in portions along the measuring pipe body.

19. The magnetic-inductive flow meter according to claim 13,
wherein the monitoring device has at least two conductors,
wherein the at least two conductors each have a support tube spacing d_{T},
wherein the support tube spacings d_{T} differ from each other at least in one measuring pipe portion.

20. The magnetic-inductive flow meter according to claim 19,
wherein the at least two conductors are connected to each other at least via a passive electrical component with an electrical impedance.

21. The magnetic-inductive flow meter according to claim 19,
wherein the measuring circuit is connected via two measuring points on the component and via two further measuring points to ends of the at least two conductors,
wherein the measuring circuit can sequentially measure the four measuring points with respect to each other.

22. The magnetic-inductive flow meter according to claim 13,
wherein the monitoring device comprises at least four conductors,
wherein pairs of conductors of the at least four conductors are connected to each other via a single passive electrical component,
wherein the at least four conductors are connected to the measuring circuit,
wherein, when the measuring pipe body is intact, the determined measured values are a function of the impedance of the at least four conductors and the at least two components.

23. The magnetic-inductive flow meter according to claim 13,
wherein the monitoring device has at least two passive electrical components, each having an electrical impedance,
wherein the at least two passive electrical components are connected in series or in parallel to each other via the at least two conductors.

24. The magnetic-inductive flow meter according to claim 19,
wherein the monitoring device comprises a multiplexer,
wherein the multiplexer is configured to sequentially connect the at least two conductors.
